(19) United States
(12) Patent Application Publication
(10) Pub. No.: US 2013/0054653 A1
(43) Pub. Date: Feb. 28, 2013

(54) METHOD OF CONSTRUCTING ETCHING PROFILE DATABASE

(71) Applicants: Ming-Tsung Hsu, New Taipei City (TW); Chun-Chi Chen, Taipei City (TW); Hao-Jan Chen, Taoyuan County (TW)

(72) Inventors: Ming-Tsung Hsu, New Taipei City (TW); Chun-Chi Chen, Taipei City (TW); Hao-Jan Chen, Taoyuan County (TW)

(21) Appl. No.: 13/253,984

(22) Filed: Oct. 6, 2011

(30) Foreign Application Priority Data
Aug. 24, 2011 (TW) 100130344

(51) Int. Cl. G06F 17/30

(52) U.S. Cl. 707/803; 707/E17.005

(57) ABSTRACT

A method of constructing a database for etching profile is disclosed. First, a standard etching group including a standard etching structure and a deviated etching group including a deviated etching structure are provided. Second, a remote sensing (RS) step is carried out to collect a standard RS data belonging to the standard etching group and a deviated RS data belonging to the deviated etching group. Then, the RS data is analyzed to infer feature parameters of the etching groups. Next, a deviated physical parameter is verified. Later, the correlation between the feature parameters and the deviated physical parameter is calculated to construct an etching profile database including the standard RS data and the deviated RS data. The etching profile database may facilitate the prediction of an unknown etching profile.

### BACKGROUND OF THE INVENTION

1. Field of the Invention

The present invention generally relates to a method of constructing a database for verifying an etching profile. In particular, the present invention is directed to a method of constructing a versatile database for verifying an etching profile by carrying out a remote sensing procedure.

2. Description of the Prior Art

In the current semiconductor technologies, the etching techniques are one of the critical techniques to form and to define various semiconductor elements. In the light of the larger and larger wafers, the etching conditions are getting harder and harder not to discriminate different parts on the wafer, which results in non-ideal profiles, such as over-etchings or under-etchings, everywhere. Any of the over-etchings or under-etchings is not an acceptable etching result and must be eliminated.

The current ubiquitous solution is, first to predict the results of the etching, then to destructively sample the wafer in accordance with the predictions, followed by the SEM (scanning electron microscope) results of the samples to verify if the etching profiles in the samples meet the predictions or not. However, a few problems are hidden in such approach.

First, the results are either under-estimated or over-estimated once the prediction is either under-sampled or distorted because the sampling is done in accordance with the predictions of the possible regions. In other words, the verification of the samples may not always be the case of the actual etching results of the entire wafer. This flaw may be compensated by sampling more.

Nevertheless, the approach by taking more samples is not practical because the wafer which has undergone the sampling procedure is not qualified as a product since the sampling procedure is on one hand destructively done and the verification by SEM on the other hand takes too much time. Given the above, a novel approach to overcome the above various problems is still needed.

### SUMMARY OF THE INVENTION

In view of the above, the present invention proposes a method of constructing a database for verifying an etching profile. In one aspect, the method of the present invention is able to predict the etching profiles of a given sample without destructively influencing the sample. Further, in another aspect, the method of the present invention is also able to comprehensively predict the etching profile of any region on a given sample in accordance with a readily established etching profile database in an extremely short period of time. To sum up, the method of the present invention is able to solve various problems as stated above.

The method of the present invention first provides a standard etching profile group and a deviated etching profile group. The standard etching profile group includes one or more standard etching structures which have acceptable profiles. The deviated etching profile group includes one or more deviated etching structures which have unacceptable profiles. Second, a remote sensing (RS) step is carried out to collect the standard remote sensing data belonging to the standard etching profile group. Again, another remote sensing step is carried out to collect the deviated remote sensing data belonging to the deviated etching profile group. Next, the standard remote sensing data are analyzed to infer a standard feature parameter of the standard etching profile group. Also, the deviated remote sensing data is analyzed to infer a deviated feature parameter of the deviated etching profile group. Later, a deviated physical parameter of the deviated etching profile group is verified. Then, a correlation between the deviated feature parameter and the deviated physical parameter is calculated to construct an etching profile database which includes the deviated remote sensing data. Furthermore, the etching profile database is suitable for use in indirectly predicting an unknown etching profile.

In one embodiment of the present invention, at least one standard etching structure is disposed in an array region or in a scrub line region.

In another embodiment of the present invention, at least one deviated etching structure is disposed in an array region or in a scrub line region.

In another embodiment of the present invention, the standard etching profile group is disposed on a reference wafer.

In another embodiment of the present invention, the deviated etching profile group is disposed on a product wafer.

In another embodiment of the present invention, the standard etching structure and the deviated etching structure are respectively disposed in a composite structure.

In another embodiment of the present invention, one or more deviated etching structures which have unacceptable profiles include an over-etching structure.

In another embodiment of the present invention, one or more deviated etching structures which have unacceptable profiles include an under-etching structure.

In another embodiment of the present invention, the remote sensing step is carried out by using an electromagnetic wave.

In another embodiment of the present invention, the electromagnetic wave is infrared.

In another embodiment of the present invention, the remote sensing step is carried out by using a group of infrared electromagnetic wave of various wavelengths.

In another embodiment of the present invention, at least one of the standard remote sensing data and the deviated remote sensing data are a reflectance of the electromagnetic wave.

In another embodiment of the present invention, the reflectance of the electromagnetic wave corresponds to at least one region of at least one of one or more standard etching structures and of one or more deviated etching structures.

In another embodiment of the present invention, at least one region includes a top region and a bottom region.

In another embodiment of the present invention, at least one region further includes a middle region.

In another embodiment of the present invention, at least one of the standard feature parameter and the deviated feature parameter is a void ratio.

In another embodiment of the present invention, at least one of the standard remote sensing data and the deviated remote sensing data is used to calculate the void ratio.

In another embodiment of the present invention, verifying the deviated physical parameter is carried out by using a physical failure analysis in a destructive way.

In another embodiment of the present invention, the method further includes verifying a standard physical parameter of the standard etching profile group.

In another embodiment of the present invention, the method further includes calculating a correlation between the standard feature parameter and the standard physical parameter.

In another embodiment of the present invention, the method further includes verifying if the correlation between the deviated feature parameter and the deviated physical parameter exceeds a pre-determined value.

In another embodiment of the present invention, the method further includes proposing a deviated physical parameter which is related to at least one deviated etching structure.

In another embodiment of the present invention, the method further includes performing the remote sensing step to collect unknown remote sensing data belonging to an unknown etching profile and predicting the unknown etching profile by using the etching profile database and the unknown remote sensing data in a non-destructive way.

In another embodiment of the present invention, the unknown etching profile is predicted to be the standard etching profile group.

In another embodiment of the present invention, the unknown etching profile is predicted to be the deviated etching profile group.

In another embodiment of the present invention, the remote sensing step is comprehensively carried out on a scrub line region to comprehensively predict the unknown etching profile by using the etching profile database.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIGS. 1-6 illustrate a possible procedure to construct the database for predicting an etching profile.

FIGS. 7-9 illustrate a method to predict an unknown etching profile.

FIG. 10 illustrates a method of the present invention to comprehensively predict an unknown etching profile in a wafer.

### DETAILED DESCRIPTION

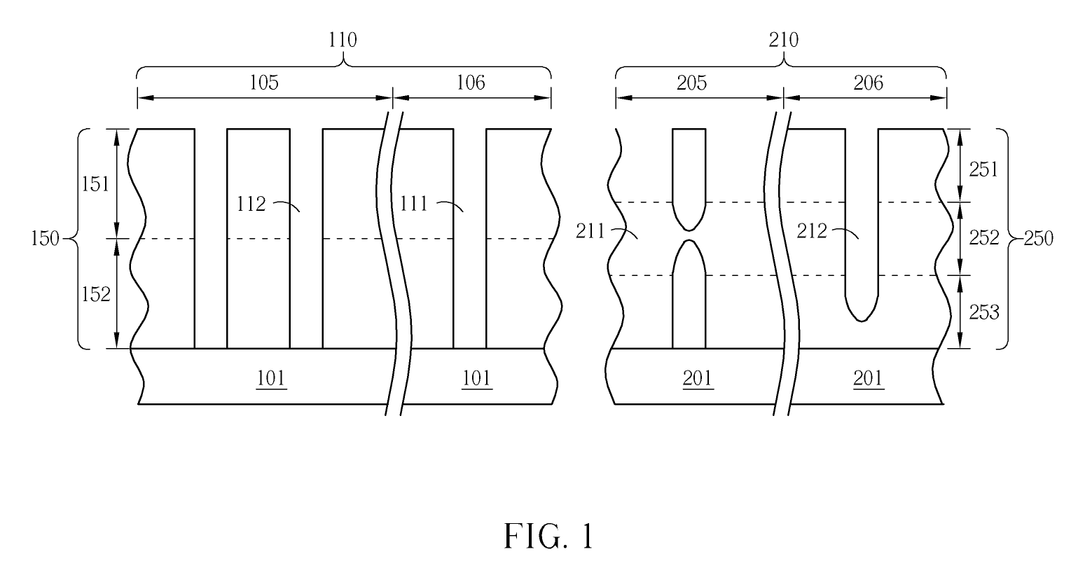

The present invention provides a method of establishing a database for the prediction of an etching profile. In one aspect, it is one feature of the method of the present invention which is able to predict the etching profiles of a given sample without damaging the sample. FIGS. 1-6 illustrate a possible procedure to construct the database for an etching profile. First, please refer to FIG. 1, a standard etching profile group 110 and a deviated etching profile group 210 are respectively provided. On one hand, the standard etching profile group 110 usually includes one or more standard etching structures 111/112 which have acceptable profiles. On the other hand, the deviated etching profile group 210 usually includes one or more deviated etching structures 211/212 which have unacceptable profiles.

Generally speaking, the standard etching profile group 110 may be disposed on a wafer 101 and the deviated etching profile group 210 may be disposed on a wafer 201. For example, the wafer 101 may be a standard wafer or a reference wafer with one or more standard etching structures 111/112 which have acceptable etching profiles which are formed by specially formulated etching recipes. On the other hand, the wafer 201 may be a reference wafer with one or more deviated etching structures 211/212 which do not have acceptable profiles by other etching recipes, or a product wafer with flaws. The wafers 101/201 may include a composite structure of multi-layers so the standard etching structures 111/112 as well as the deviated etching structures 211/212 may be respectively disposed in a composite structure.

The wafers 101/201 respectively have an array region 105/205 and a scrub line region 106/206 so the standard etching profile group 110 may be disposed on at least one of the array region 105 and the scrub line region 106. Similarly, the deviated etching profile group 210 may be disposed on at least one of the array region 205 and the scrub line region 206. As shown in FIG. 1, a deviated etching structure may be an over-etching structure 211 or an under-etching structure 212.

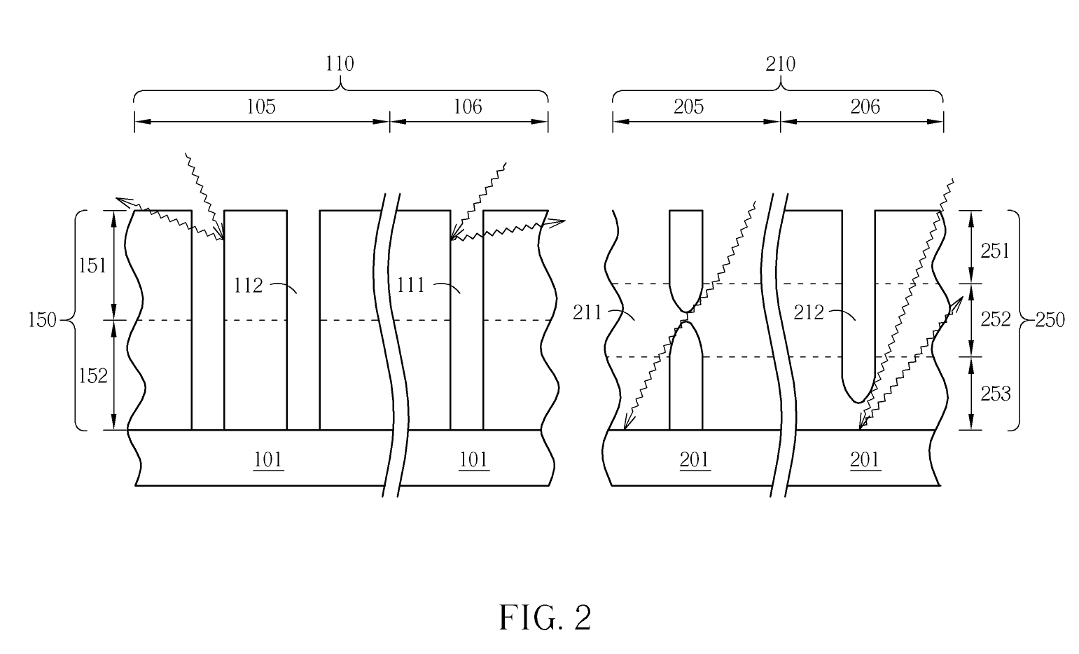

Second, please refer to FIG. 2, a remote sensing (RS) step is carried out. This remote sensing step is able to collect the standard remote sensing data belonging to the standard etching profile group 110, or to collect the deviated remote sensing data belonging to the deviated etching profile group 210 in the absence of direct contact. Preferably, the remote sensing step for collecting the standard remote sensing data and the remote sensing step for collecting the deviated remote sensing data may be separately or independently carried out in any preferred order. Apart from this, there is no metal structure, such as MOS or interlayer connection, at the upper part of the wafer when the remote sensing step is carried out. Accordingly, the remote sensing step may be used in measuring the deep trenches of the stack capacitor structure.

The remote sensing technique is generally considered as a technology to determine the physical properties of an object by an apparatus by means of detecting the electromagnetic waves which are emitted by or reflected by the object. The apparatus for use in the remote sensing does nothing but indirect and remote measurement rather than in direct contact with the object. Broadly speaking, to do a remote sensing is a way to obtain the message of an object by an indirect means.

Optionally, an electromagnetic wave may be used to do the remote sensing. For example, an electromagnetic wave of a suitable wavelength or electromagnetic waves of different wavelengths may be used to do the remote sensing. For instance, it may be a visible-near infrared remote sensing, infrared remote sensing or a microwave remote sensing. The infrared electromagnetic wave may have a wavelength from 770 nm to 1 mm to detect the physical conditions deep under the surface of a wafer. The remote sensing of the present invention may be an active remote sensing (active generation of signals).

The composite structure of multi-layers 150/250 may include a top region 151/251 and a bottom region 152/252. Moreover, the composite structure of multi-layers 150/250 may further include a middle region, such as a middle region 253. However, it is not limited to this. As a result, the composite structure of the multi-layers 150/250 may optionally further include three or more regions. On the other hand, when the wafer 101/201 includes the composite structure of multi-layers 150/250, different sets of reflectance may be detected once an electromagnetic wave passes through the composite structure of multi-layers. In other words, at least one region or material layer in the standard etching structures 111/112 should have different kinds of reflectance with respect to the electromagnetic wave. Similarly, at least one region or material layer in the deviated etching structures 211/212 should have different kinds of reflectance with respect to the electromagnetic wave, too.

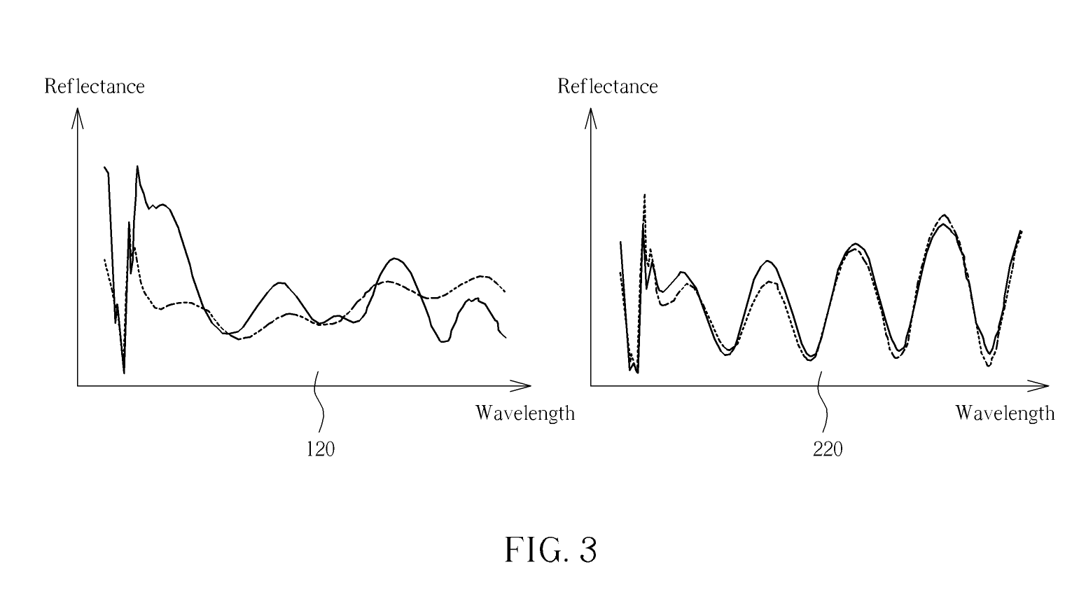

Next, as shown in FIG. 3, the standard remote sensing data are analyzed to infer a standard feature parameter 120 of the standard etching profile group 110. For example, different results are obtained when an electromagnetic wave passes through a void or a physical material because voids are formed due to etching some of the physical materials in the wafer. One of the possible results may be different kinds of reflectance when an electromagnetic wave passes through a void and a physical material in a region. Accordingly, the standard remote sensing data or the deviated remote sensing data which is collected may be the reflectance of the electromagnetic wave.

Even though the standard remote sensing data or the deviated remote sensing data which are collected may be the mixtures of regions 151/152 or the material layers 251/252/253, there are already known methods, such as Fourier transform, able to resolute the remote sensing data with multiple components to obtain the remote sensing data of a single region or a single layer.

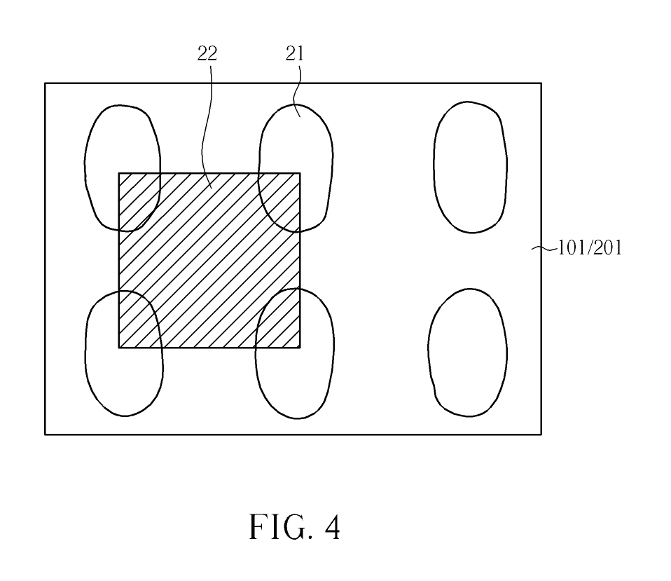

For example, please refer to FIG. 4, the voids in the wafer should be respectively different with respect to different etching profile groups because the etching removes some of the physical materials in the wafer to form different shapes of voids. In other words, the void is supposed to be somewhat related to the remote sensing data and the remote sensing data may be connected to a possible physical parameter, the void ratio for example, through an inferred feature parameter. Here the void ratio is defined as the ratio of the area of the void 22 to the area of a unit region 22 on the wafer 101/201.

Void Ratio=area of the void/area of the unit region

In view of this definition, it is reasonable to speculate that an over-etching structure 211 is supposed to have a larger deviated feature parameter 220 or an under-etching structure 212 is supposed to have a smaller deviated feature parameter 220.

Further, as shown in FIG. 3, similarly the deviated remote sensing data is also analyzed to infer a deviated feature parameter 220 of the deviated etching profile group 210. As described earlier, different etching profile groups may result in different void ratios in the wafers. Consequently, different deviated remote sensing data are analyzed in order to infer the deviated feature parameter which specifically corresponds to a certain deviated etching profile group. In other words, the deviated remote sensing data are employed to infer the connections between the deviated feature parameter(s) and some possible physical parameter(s), the void ratio for instance.

In one possible scenario, please refer to FIG. 1, an over-etching structure 211 may have two adjacent trenches which connect each other at some point. In another possible scenario, an under-etching structure 212 may have a trench of insufficient depth which fails to reach to the underlying layer.

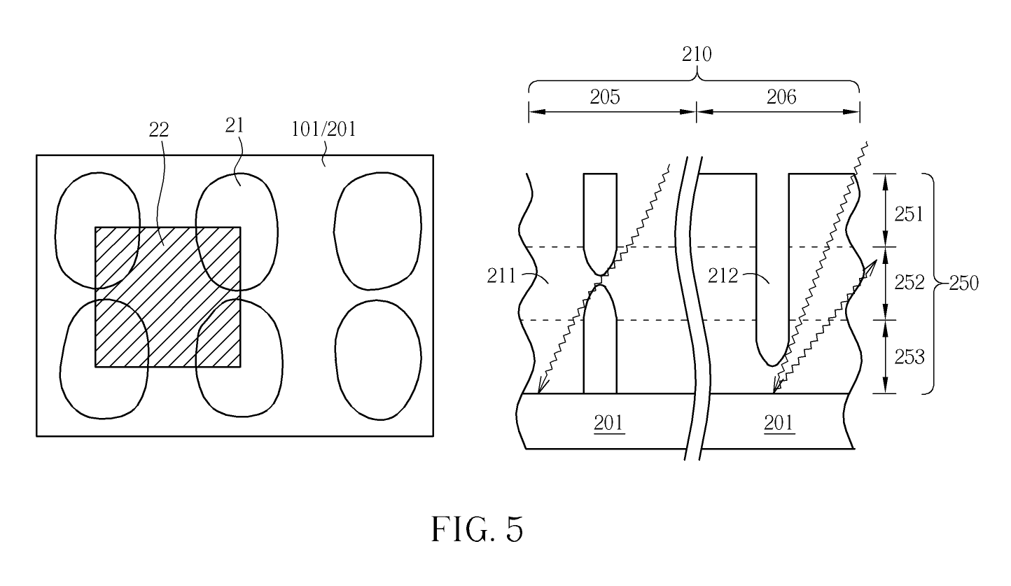

Later, please refer to FIG. 5, a deviated physical parameter of the deviated etching profile group is going to be verified. Since the deviated remote sensing data are a result which is obtained by indirectly measuring the deviated etching profile group 210, it is necessary to verify if there is a suitable relationship between the deviated feature parameter 220 which is indirectly obtained and the deviated physical parameter, the void ratio for instance, which is actually inferred.

For example, the void ratios for the standard etching profile group 110 and for the deviated etching profile group 210 may be respectively verified. The method for verification may be the widely accepted physical failure analysis. For instance, the physical failure analysis maybe carried out as follows. First, the electron microscope images of the standard etching profile group 110 and of the deviated etching profile group 210 are respectively obtained by a destructive way. Then, the actual standard physical parameter, for instance the void ratio, of the standard etching profile group 110 and the actual deviated physical parameter of the deviated etching profile group 210, for instance the void ratio, in accordance the results of the images may be respectively calculated.

Apart from these, the method of the present invention may optionally further include the step for proposing another distinct deviated physical parameter which is possibly related to both the standard etching structures and the deviated etching structures at the same time. For example, because the resultant standard remote sensing data as well as the deviated remote sensing data may be the spectrum of a reflectance of the electromagnetic wave, it is also expected to discover another feature parameter which is associated with the spectrum of the reflectance of the electromagnetic wave, and to further facilitate the inference of an unknown etching profile group.

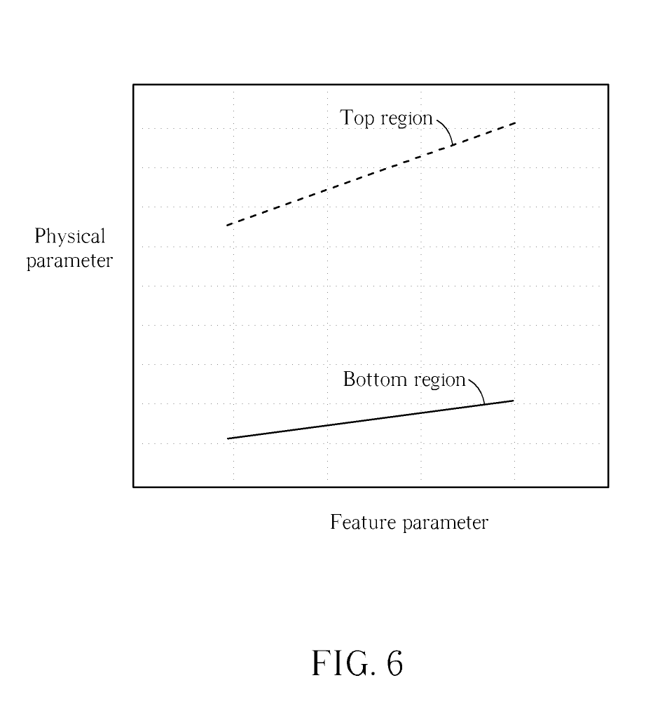

After that, please refer to FIG. 6, because the standard physical parameter and the deviated physical parameter are available through the physical failure analysis and the standard remote sensing data and the deviated remote sensing data are obtained in the previous steps, the above information can be integrated in a following mapping step to calculate if there is a correlation between the deviated feature parameter and the deviated physical parameter or to calculate how good the correlation is to construct an etching profile database which includes the deviated remote sensing data. Such etching profile database is useable in predicting an unknown etching profile. In addition, it is also possible to calculate if there is a correlation between the standard feature parameter and the standard physical parameter or how good the correlation is to establish another etching profile database which includes the standard remote sensing data. For example, a correlation coefficient may be used as an objective basis to evaluate if such correlation exists or if such correlation is good enough.

For example, when a correlation between the deviated feature parameter and the deviated physical parameter exceeds a pre-determined expectation, it is determined that there is a suitable correlation between the deviated feature parameter and the deviated physical parameter. Similarly, when a correlation between the standard feature parameter and the standard physical parameter exceeds a pre-determined expectation, it is also determined that there is a suitable correlation between the standard feature parameter and the standard physical parameter.

The following examples are some demonstrations of the correlations among the remote sensing data, the feature parameters and the physical parameters of the present invention.

| | WAFER 1 | WAFER 2 | WAFER 3 | WAFER 4 | R²(*) |
|---|---|---|---|---|---|
| VOID RATIO | 0.61 | 0.66 | 0.69 | 0.61 | — |
| CD1_S | 73.40 | 76.76 | 78.44 | 72.79 | 0.98 |
| CD2_S | 55.62 | 57.59 | 59.22 | 54.99 | 0.98 |
| CD1_A | 75.60 | 76.34 | 77.45 | 75.28 | 0.96 |
| CD2_A | 56.95 | 57.75 | 58.65 | 56.90 | 0.99 |

(*)Remark: R stands for a correlation coefficient.

CD1 and CD2 each stands for a kept physical trait of a wafer after being processed. S stands for “standard” and “A” stands for “deviated.”

a*x+b=y in which a and b are constants, x=CD1 or CD2, and y=void ratio.

The above correlation formula, such as the combination or the power, may be modified in accordance with the structures involved.

If there is no suitable correlation between the feature parameters and the physical parameters able to be constructed through the above steps, or the correlation between the feature parameters and the physical parameters is not good enough, or a correlation between the feature parameters and another physical parameter is still needed, the method of the present invention further includes the steps to propose another possible physical parameter which is related to the etching structure and to repeat the above steps till a suitable or satisfying correlation between the feature parameters and the physical parameters is found.

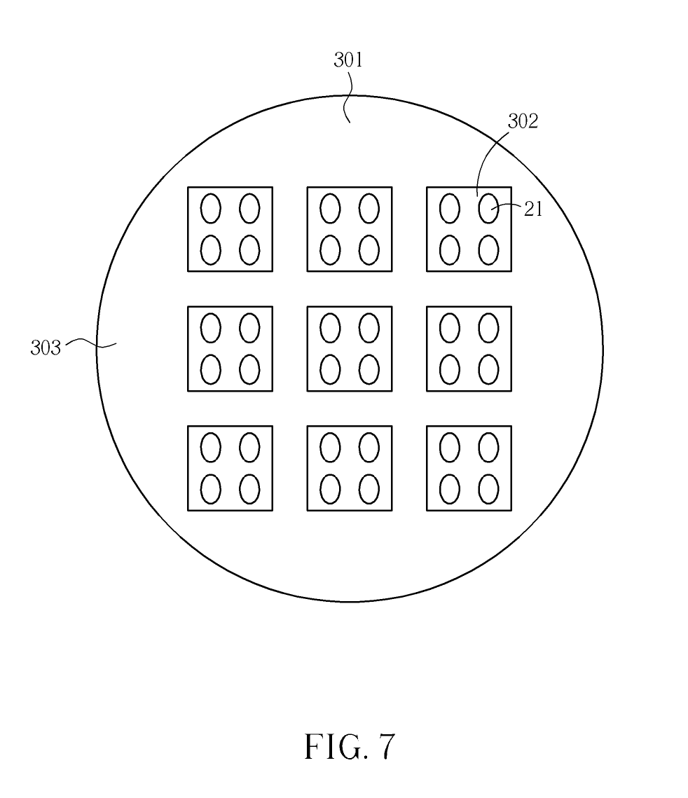

When the etching profile database is established, it is readily used to non-destructively predict if an unknown etching profile belongs to a standard etching profile group or to a deviated etching profile group. FIGS. 7-9 illustrate a method to predict an unknown etching profile. First, please refer to FIG. 7, a wafer 301 with an unknown etching profile 310 is provided. The wafers 301 may have an array region 302 and a scrub line region 303 so the unknown etching profile 310 may be disposed on at least one of the array region 302 and the scrub line region 303. The unknown etching profile 310 may be a capacitor trench in a dynamic random access memory (DRAM). The wafer 301 maybe a product wafer from a production line. Optionally, the wafers 301 may include a composite structure of multi-layers so the unknown etching profile 310 may be disposed in a composite structure.

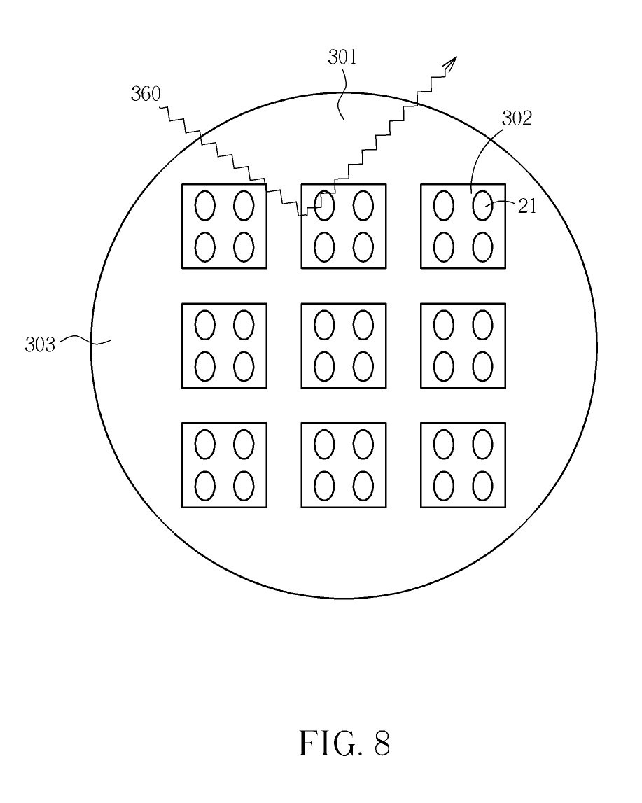

Next, please refer to FIG. 8, a remote sensing step 360 is carried out on the unknown etching profile 310 of the wafer 301 to collect the unknown remote sensing data belonging to the unknown etching profile group 310. This remote sensing step 360 actually collects the unknown remote sensing data belonging to the unknown etching profile group 310 in the absence of direct contact. Furthermore, there is no metal structure, such as MOS or interlayer connection, at the upper part of the wafer when the remote sensing step is carried out. Optionally, an electromagnetic wave may be used to do the remote sensing. For example, an electromagnetic wave of a suitable wavelength or of different wavelengths may be used to do the remote sensing step 360. An electromagnetic wave of a suitable wavelength may be infrared. The infrared electromagnetic wave may have a wavelength from 770 nm to 1 mm to detect the physical conditions deep under the surface of a wafer.

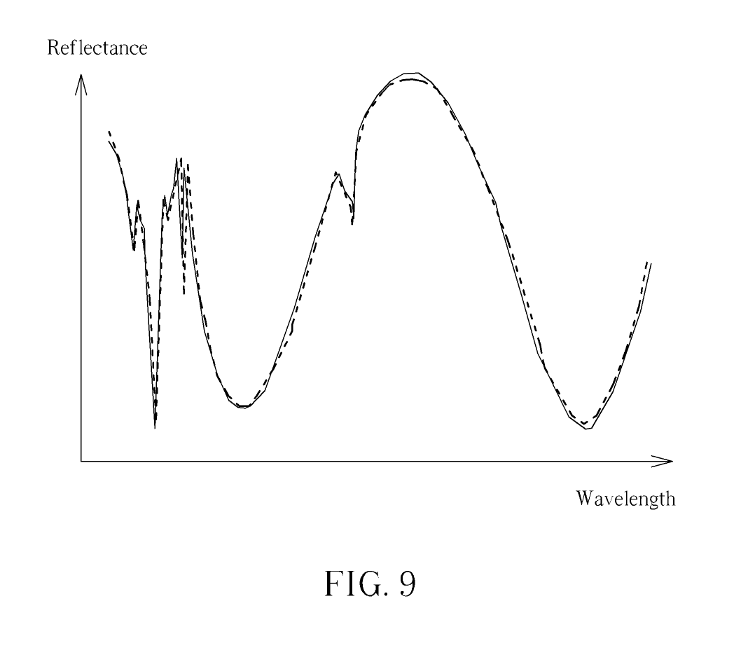

Then, as shown in FIG. 9, the various standard feature parameters or deviated feature parameters in the etching profile database are used to correspond to the unknown remote sensing data by referring to the previously constructed etching profile database. In such a way, it is determined if the unknown remote sensing data belong to the standard feature parameters or the deviated feature parameters. In one embodiment of the present invention, it is determined or predicted that the unknown etching profile belongs to the standard etching profile group because the unknown remote sensing data are consistent with the ranges or with the traits of the standard feature parameters in the etching profile database. In another embodiment of the present invention, it is determined or predicted that the unknown etching profile belongs to the deviated etching profile group because the unknown remote sensing data are consistent with the ranges or with the traits of the deviated feature parameters in the etching profile database.

Since such standard feature parameters or deviated feature parameters have been verified by the physical failure analysis in previous steps, the resultant determinations or predictions surely have extremely high credibility. Moreover, these determinations or predictions of the etching profiles are done by non-destructive procedures so the commercial value of the product wafers would not be diminished or compromised.

Given that these determinations or predictions of the etching profiles are done without damaging the samples, another method of the present invention to comprehensively predict the etching profiles in any region of a given sample is also provided. This method is able to comprehensively predict the unknown etching profiles in any region of a given sample in an extremely short period of time in accordance with the versatile etching profile database proposed by the present invention.

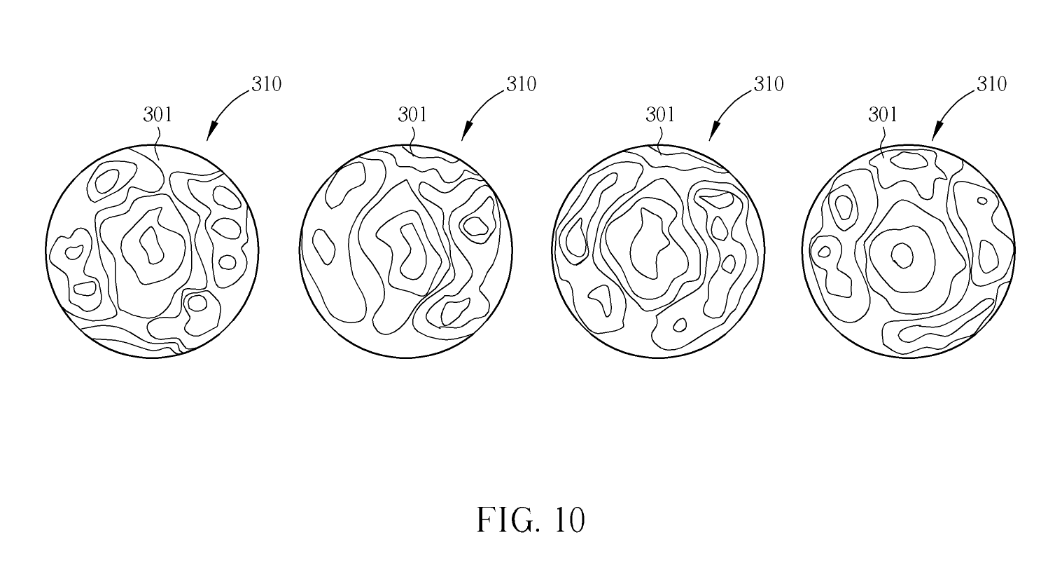

Because an unknown etching profile 310 may be disposed within any array region 302 or scrub line region 303, the method of the present invention is also capable of comprehensively carrying out a remote sensing step on each and every array region 302 or scrub line region 303 of a wafer 301. FIG. 10 illustrates a method of the present invention to comprehensively predict an unknown etching profile in a wafer. Please refer to FIG. 10, a remote sensing step is carried out to collect most or even all of the unknown remote sensing data of an unknown etching profile 310 disposed within an array region 302 or an scrub line region 303 of a wafer 301 in an extremely short period of time, for example less than 10 seconds for each sample point, because the remote sensing step may use an electromagnetic wave to non-destructively collect the unknown remote sensing data belonging to an unknown etching profile 310. Then, please refer to FIG. 9, the previously described principles are used to comprehensively predict the unknown etching profiles 310 in an array region 302 or in a scrub line region 303 of a wafer 301 in accordance with the previously established etching profile database proposed by the present invention.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A method of constructing a database for an etching profile, comprising:
providing a standard etching profile group comprising at least one standard etching structure which is acceptable as well as a deviated etching profile group comprising at least one deviated etching structure which is not acceptable;
performing a remote sensing (RS) step to collect a standard remote sensing data belonging to said standard etching profile group;
performing said remote sensing step to collect a deviated remote sensing data belonging to said deviated etching profile group;
respectively analyzing said standard remote sensing data and said deviated remote sensing data to infer a standard feature parameter of said standard etching profile group as well as a deviated feature parameter of said deviated etching profile group;
verifying a deviated physical parameter of said deviated etching profile group; and
calculating a correlation between said deviated feature parameter and said deviated physical parameter to construct an etching profile database which comprises said deviated remote sensing data and is for use in indirectly predicting an unknown etching profile.

2. The method of constructing a database for an etching profile of claim 1, wherein said at least one standard etching structure is disposed in at least one of an array region and a scrub line region.

3. The method of constructing a database for an etching profile of claim 1, wherein said at least one deviated etching structure is disposed in at least one of an array region and a scrub line region.

4. The method of constructing a database for an etching profile of claim 1, wherein said standard etching profile group is disposed on a reference wafer.

5. The method of constructing a database for an etching profile of claim 1, wherein said deviated etching profile group is disposed on a product wafer.

6. The method of constructing a database for an etching profile of claim 1, wherein said standard etching structure and said deviated etching structure are respectively disposed in a composite structure.

7. The method of constructing a database for an etching profile of claim 1, wherein said at least one deviated etching structure which is not acceptable comprises an over-etching structure.

8. The method of constructing a database for an etching profile of claim 1, wherein said at least one deviated etching structure which is not acceptable comprises an under-etching structure.

9. The method of constructing a database for an etching profile of claim 1, wherein said remote sensing step is performed by using an electromagnetic wave.

10. The method of constructing a database for an etching profile of claim 9, wherein said electromagnetic wave is infrared.

11. The method of constructing a database for an etching profile of claim 10, wherein said remote sensing step is performed by using said infrared electromagnetic wave of various wavelengths.

12. The method of constructing a database for an etching profile of claim 9, wherein at least one of said standard remote sensing data and said deviated remote sensing data is a reflectance of said electromagnetic wave.

13. The method of constructing a database for an etching profile of claim 12, wherein said reflectance of said electromagnetic wave corresponds to at least one region of at least one of said at least one standard etching structure and of said at least one deviated etching structure.

14. The method of constructing a database for an etching profile of claim 13, wherein said at least one region comprises a top region and a bottom region.

15. The method of constructing a database for an etching profile of claim 14, wherein said at least one region further comprises a middle region.

16. The method of constructing a database for an etching profile of claim 1, wherein at least one of said standard feature parameter and said deviated feature parameter is a void ratio.

17. The method of constructing a database for an etching profile of claim 16, wherein at least one of said standard remote sensing data and said deviated remote sensing data is used to calculate said void ratio.

18. The method of constructing a database for an etching profile of claim 1, wherein verifying said deviated physical parameter is performed by using a physical failure analysis in a destructive way.

19. The method of constructing a database for an etching profile of claim 1, further comprising:
verifying a standard physical parameter of said standard etching profile group.

20. The method of constructing a database for an etching profile of claim 1, further comprising:
calculating a correlation between said standard feature parameter and said standard physical parameter.

21. The method of constructing a database for an etching profile of claim 1, further comprising:
verifying if said correlation between said deviated feature parameter and said deviated physical parameter exceeds a pre-determined value.

22. The method of constructing a database for an etching profile of claim 1, further comprising:
proposing said deviated physical parameter which is related to said at least one deviated etching structure.

23. The method of constructing a database for an etching profile of claim 1, further comprising:
performing said remote sensing step to collect an unknown remote sensing data belonging to said unknown etching profile; and
predicting said unknown etching profile by using said etching profile database and said unknown remote sensing data in a non-destructive way.

24. The method of constructing a database for an etching profile of claim 23, wherein said unknown etching profile is predicted to belong to said standard etching profile group.

25. The method of constructing a database for an etching profile of claim 23, wherein said unknown etching profile is predicted to belong to said deviated etching profile group.

26. The method of constructing a database for an etching profile of claim 1, wherein said remote sensing step is comprehensively performed on a scrub line region to comprehensively predict said unknown etching profile by using said etching profile database.
